(19) United States
(12) Patent Application Publication
(10) Pub. No.: US 2019/0235296 A1
(43) Pub. Date: Aug. 1, 2019

(54) ALIGNMENT FILM MANUFACTURING METHOD, LIQUID CRYSTAL DISPLAY PANEL, AND LIQUID CRYSTAL DISPLAY

(71) Applicant: Shenzhen China Star Optoelectronics Technology Co. , Ltd., Shenzhen (CN)

(72) Inventors: Zhengkun Liu, Shenzhen (CN); Jie Chen, Shenzhen (CN)

(21) Appl. No.: 15/993,997

(22) Filed: May 31, 2018

Related U.S. Application Data
(63) Continuation of application No. PCT/CN2018/077089, filed on Feb. 24, 2018.

(30) Foreign Application Priority Data
Jan. 29, 2018 (CN) 201810086493.3

(51) Int. Cl. G02F 1/1337; G02F 1/1339

(52) U.S. Cl. CPC G02F 1/13378; G02F 1/133784; G02F 1/1368; G02F 1/1339; G02F 1/133788

(57) ABSTRACT

The present disclosure provides an alignment film manufacturing method, a liquid crystal display panel, and a liquid crystal display. The alignment film manufacturing method includes: providing a substrate; defining an active display area and a sealant area on the substrate, wherein the sealant area is a strip area arranged around the active display area, and there is a predetermined distance between the sealant area and the active display area; arranging an alignment film on the substrate, wherein the alignment film covers at least a part of the active display area; and etching the alignment film, so that an edge of the alignment film is located between an edge of the active display area and the sealant area. By the above-mentioned one or more implementations, the present disclosure may improve an adhesion force between the sealant and the substrate.

### CROSS-REFERENCE TO RELATED APPLICATIONS

The present application is a continuation-application of International (PCT) Patent Application No. PCT/CN2018/077089, field on Feb. 24, 2018, which claims foreign priority of Chinese Patent Application No. 201810086493.3, field on Jan. 29, 2018 in the State Intellectual Property Office of China, the entire contents of which are hereby incorporated by reference.

### FIELD

The present disclosure relates to a technology of display, and more particularly, to an alignment film manufacturing method, a liquid crystal display panel, and a liquid crystal display.

### BACKGROUND

With the development of display technology, the requirement for consumer electronic products has not only been limited to functionality, but also to design, artistry and good visual experience. For example, current popular ultra-narrow border display products. The ultra-narrow border refers to further narrow a border of traditional thin film transistor liquid crystal displays, to further expand an area of an active display area (AA), so as to achieve a higher level of visual experience and product design aesthetics.

Sealant coatings become more important, and an adhesive force between a plastic frame and a substrate, affects the panel quality and the yield greatly.

### SUMMARY

The present disclosure provides an alignment film manufacturing method, a liquid crystal display panel, and a liquid crystal display to solve the technical problem, which may improve an adhesion force between the sealant and the substrate.

In order to solve the above-mentioned technical problem, a technical solution adopted by the present disclosure is to provide an alignment film manufacturing method comprising: providing a substrate; defining an active display area and a sealant area on the substrate, wherein the sealant area is a strip area arranged around the active display area, and there is a predetermined distance between the sealant area and the active display area; coating alignment film solution on the substrate; baking the substrate, to cure the alignment film solution to form the alignment film; enabling a liquid crystal molecule alignment ability of the alignment film by one of a rubbing alignment manner and a photo alignment manner, wherein the alignment film covers at least a part of the active display area; etching the alignment film by a gas lithography technology, so that an edge of the alignment film is located between an edge of the active display area and the sealant area.

In order to solve the above-mentioned technical problem, a technical solution adopted by the present disclosure is to further provide an alignment film manufacturing method comprising: providing a substrate; defining an active display area and a sealant area on the substrate, wherein the sealant area is a strip area arranged around the active display area, and there is a predetermined distance between the sealant area and the active display area; arranging an alignment film on the substrate, wherein the alignment film covers at least a part the active display area; etching the alignment film, so that an edge of the alignment film is located between an edge of the active display area and the sealant area.

In order to solve the above-mentioned technical problem, a technical solution adopted by the present disclosure is to further provide a liquid crystal display comprising a liquid crystal display panel and a backlight; the liquid crystal display panel comprising an array substrate, a color filter substrate, and a liquid crystal layer between the array substrate and the color filter substrate, wherein the array substrate and the color filter substrate are connected by a sealant area; an alignment film is arranged on at least one of the array substrate and the color filter substrate, the at least one of the array substrate and the color filter substrate comprises an active display area and the sealant area; an edge of the alignment film are located between the sealant area and an edge of an active display area.

Advantages of the disclosure may follow. As compared with the related art, the present disclosure provides an alignment film manufacturing method, a liquid crystal display panel, and a liquid crystal display. The alignment film manufacturing method comprises: providing a substrate; defining an active display area and a sealant area on the substrate, wherein the sealant area is a strip area arranged around the active display area, and there is a predetermined distance between the sealant area and the active display area; coating alignment film solution on the substrate; baking the substrate, to cure the alignment film solution to form the alignment film; enabling a liquid crystal molecule alignment ability of the alignment film by one of a rubbing alignment manner and a photo alignment manner, wherein the alignment film covers at least a part of the active display area; etching the alignment film by a gas lithography technology, so that an edge of the alignment film is located between an edge of the active display area and the sealant area. By the above-mentioned one or more implementations, the present disclosure may improve an adhesion force between the sealant and the substrate by a small portion which the sealant coated on the substrate. As compared with an entire alignment film which the sealant coated and having a same adhesion force, a size of a portion which the sealant coated may reduce in the present disclosure, and may meet requirements of a sealant coating for a narrow border substrate.

### BRIEF DESCRIPTION OF THE DRAWINGS

In order to clearly illustrate the technical solutions of the present disclosure, the drawings used in the description of the embodiments will be briefly described. It is understood that the drawings described herein are merely some embodiments of the present disclosure. Those skilled in the art may derive other drawings from these drawings without inventive effort.

FIG. 1 is a flow chart of an alignment film manufacturing method in accordance with an embodiment in the present disclosure;

FIG. 2 is a schematic diagram illustrating an active display area, a sealant area, and a gas lithography boundary in accordance with an embodiment in the present disclosure;

FIG. 3 is a flow chart of an alignment film manufacturing method in accordance with another embodiment in the present disclosure;

FIG. 4 is a structural illustration of a liquid crystal display panel in accordance with an embodiment in the present disclosure;

FIG. 5 is a structural illustration of a liquid crystal display in accordance with an embodiment in the present disclosure.

### DETAILED DESCRIPTION

The detailed description set forth below is intended as a description of the subject technology with reference to the appended figures and embodiments. It is understood that the embodiments described herein include merely some parts of the embodiments of the present disclosure, but do not include all the embodiments. Based on the embodiments of the present disclosure, all other embodiments that those skilled in the art may derive from these embodiments are within the scope of the present disclosure.

Reference herein to “an embodiment” means that a particular feature, a structure, or a characteristic described in connection with the embodiment may be included in at least one embodiment of the disclosure. The appearances of the phrase in various places in the specification are not necessarily all referring to the same embodiment, nor are separate or alternative embodiments mutually exclusive of other embodiments. The skilled in the art explicitly and implicitly understand that the embodiments described herein may be combined with other embodiments.

Referring to FIG. 1, FIG. 1 is a flow chart of an alignment film manufacturing method in accordance with an embodiment in the present disclosure.

Block 11: a substrate is provided.

A substrate may be provided, the substrate may be one of an array substrate, a color filter substrate, a color filter substrate, and a substrate similar to the array substrate.

For example, a color filter on array (COA) type array substrate. A filter layer is arranged on an array substrate, a common electrode layer is arranged on a color filter substrate opposite to the filter layer, and the filter layer may not be arranged on the color filter substrate.

The substrate may comprise a plurality of display regions and a plurality of non-display regions between the plurality of display regions. A sealant area or a conductive glue may be printed on the non-display region to prepare for subsequent packing.

A display region on the array substrate may comprises a thin film transistor array and a pixel electrode, and a display region on the color filter substrate may comprises a filter layer and a common electrode. Therefore, the substrate provided by the present disclosure herein may refer to a substrate for each necessary process before the alignment film has been completed.

Block 12: an active display area and a sealant area are defined on the substrate.

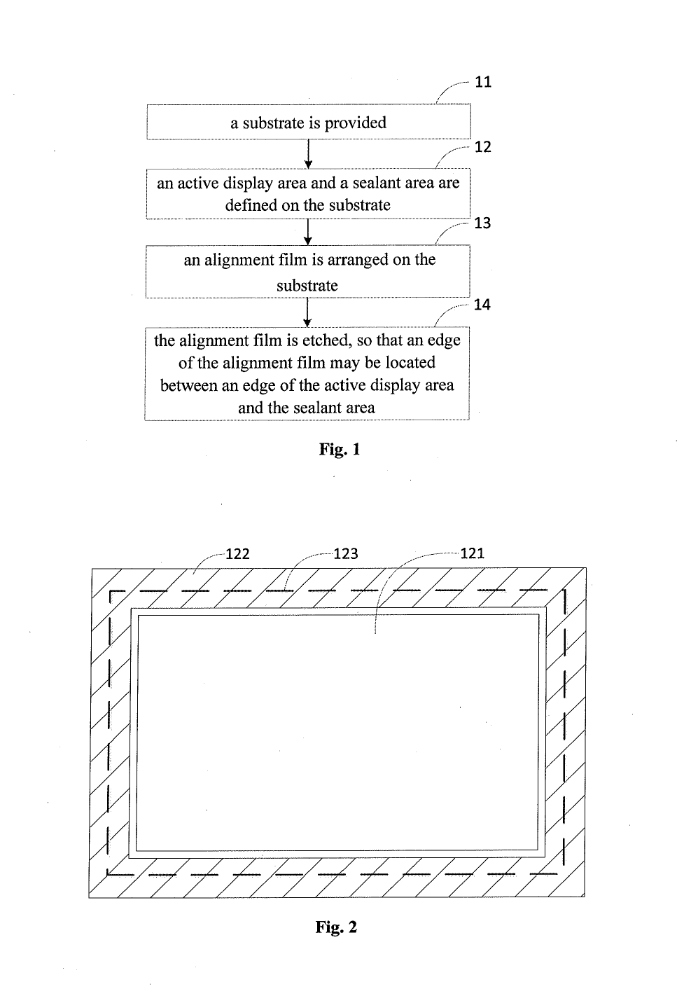

Referring to FIG. 2, an active display area 121 and a sealant area 122 may be defined on the substrate. The sealant area 122 may be arranged on the non-display region on the substrate, and which may be a strip area arranged around the active display area 121. There may be a predetermined distance between the sealant area 122 and the active display area 121.

It should be noticed that, the active display area 121 may be located in the display area on the substrate, and the sealant area 122 may be located in the non-display area. There may be a predetermined distance between the sealant area 122 and the active display area 121, to reserve some space for fault-tolerant when coating the sealant area, so that a success rate of sealant coating may be increased.

Block 13: an alignment film is arranged on the substrate.

An alignment film is arranged on the substrate. The alignment film may cover at least a part of the active display area.

Specifically, alignment film solution may be coated on the substrate; the substrate may be baked, to cure the alignment film solution to form the alignment film; and a liquid crystal molecule alignment ability of the alignment film may be enabled by one of a rubbing alignment manner and a photo alignment manner.

More specifically, the alignment film solution may be coated on the substrate by one of a means of relief printing manner and an inkjet printing manner. The substrate which the alignment film solution is coated may be pre-baked to preliminarily dry the coating to flatten the film surface, and may be baked at a predetermined temperature and a predetermined time to be cured the alignment film solution to form an alignment film. The liquid crystal molecule alignment ability of the alignment film may be enabled. For example, the alignment film may be rubbed in a fixed direction by a velvet to complete an alignment. In a liquid crystal display panel, liquid crystal molecules at the alignment film may be arranged in parallel in a rubbing direction; or the alignment film may be irradiated with an ultraviolet light at a predetermined angle to an alignment.

Block 14: the alignment film is etched, so that an edge of the alignment film may be located between an edge of the active display area and the sealant area.

The alignment film may be etched, so that an edge of the alignment film may be located between an edge of the active display area and the sealant area. During a process of coating the alignment film, the alignment film solution may inevitably cover the non-display area on the substrate, to ensure that the alignment film may completely cover the active display area.

In the related art, the alignment film often covers the sealant area. Especially in current, narrow border display panel has become a popular trend, and a narrower sealant area may be easily covered by the alignment film, to become a problem in manufacturing the narrow border display panel. Therefore, in the present disclosure, an range covered by the alignment film may be adjusted by etching after the alignment film is prepared, so that when covering the active display area, the sealant area may not be covered completely, to ensure that at least a small portion of the sealant area may be arranged on the substrate instead of being arranged on the alignment film completely, thereby the adhesion force may be increased.

In the present disclosure, an alignment film may be etched by a gas lithography technology, so that an edge of the alignment film may be located between an edge of the active display area and the sealant area.

A range covered by the alignment film may be adjusted by one of a laser etching method and a plasma etching method.

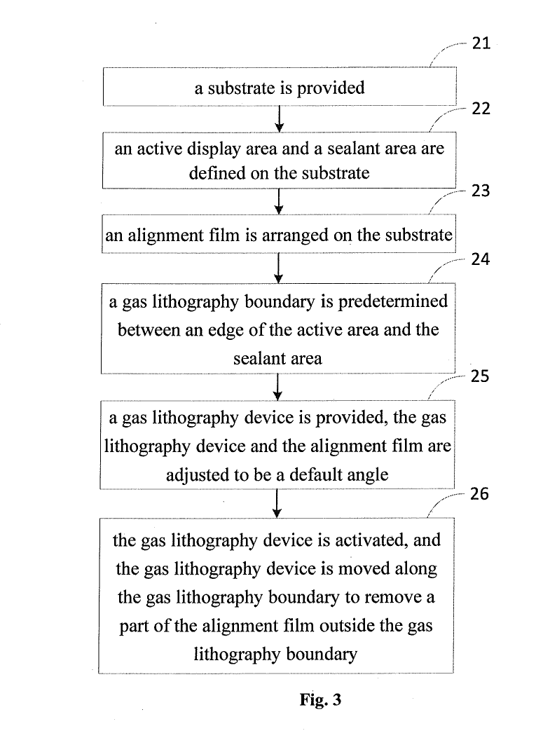

Referring to FIG. 3, FIG. 3 is a flow chart of an alignment film manufacturing method in accordance with another embodiment in the present disclosure.

Block 21: a substrate is provided.

Block 22: an active display area and a sealant area are defined on the substrate.

Block 23: an alignment film is arranged on the substrate.

Block 24: a gas lithography boundary is predetermined between an edge of the active display area and the sealant area.

Referring to FIG. 2, a gas lithography boundary 123 may be predetermined between the edge of the active display area 121 and the sealant area 122 (the boundary is a hypothetical boundary, and which is not shown in the Fig.). Specifically, the gas lithography boundary 123 may be located between the edge of the active display area 121 and the sealant area 122, and adjacent to side of active display area 121.

If an area which the alignment film covers the sealant area 122, is excessive, even if a part of sealant area is coated on portions where the alignment film is not covered on the substrate, an adhesion force may not meet requirements. Therefore, the gas lithography boundary 123 should be predetermined reasonably, so that the adhesion force between the sealant area and the substrate may meet the requirements, to ensure that an array substrate and a color filter substrate of a display panel may be connected by the sealant area without falling off, and to a quality and a yield of the panel may be increase.

The gas lithography boundary may be calculated by a computer program by photographing the substrate, by a visual camera, i.e., positions of the gas lithography boundary may be calculated and converted into data in two-dimensional coordinates, and the gas lithography boundary may be adjusted precisely according to the data.

Block 25: a gas lithography device is provided, the gas lithography device and the alignment film are adjusted to be a default angle.

A gas lithography device is provided, the gas lithography device and the alignment film may be adjusted to be a default angle, for preparing to remove a part of the alignment film. A suitable default angle may ensure to a certain extent that even if a gas pressure of the gas lithography device suddenly increases, the substrate will not be damaged. In addition, there may be a suitable distance between an air outlet of the gas lithography device and the alignment film.

The gas lithography device may be one of an air gun device and an air knife device, which may be capable of ejecting a gas flow to reach a proper initial velocity, it is not limited in the present disclosure.

Block 26: the gas lithography device is activated, and the gas lithography device is moved along the gas lithography boundary to remove a part of the alignment film outside the gas lithography boundary.

A gas pressure of the gas lithography device may be detected, and the gas pressure of the gas lithography device may be adjusted, so that the gas pressure of the gas lithography device may be greater than an etching strength threshold of the alignment film. In this case, because the gas lithography device and the alignment film may be adjusted to be a default angle, the gas pressure may refers to a minimum gas pressure of an airflow ejected by the gas lithography device in the default angle, which may clear the alignment film. When the gas pressure of the gas lithography device becomes greater, an initial velocity of the airflow may become greater. Even if the airflow has a certain deceleration before reaching to the alignment film, speed of the airflow may still become greater, so that an etching strength to the alignment film may become greater. Therefore, the gas pressure of the gas lithography device may be adjusted, and the etching strength of the airflow striking the alignment film may be greater than the etching strength threshold of the alignment film.

The gas lithography device may be activated, and the gas lithography device may be moved along the gas lithography boundary to remove a part of the alignment film outside the gas lithography boundary. When the gas pressure of the gas lithography device is adjusted to reach to a suitable pressure value, the gas lithography device may be activated, and the gas lithography device may be moved along the gas lithography boundary to remove the part of the alignment film outside the gas lithography boundary.

In the present embodiment, gas used in the gas lithography technology may be selected from the group consisting of carbon dioxide, compressed air, and nitrogen. In addition, other gas may be used instead of the above-mentioned gas, it is not limited in the present disclosure.

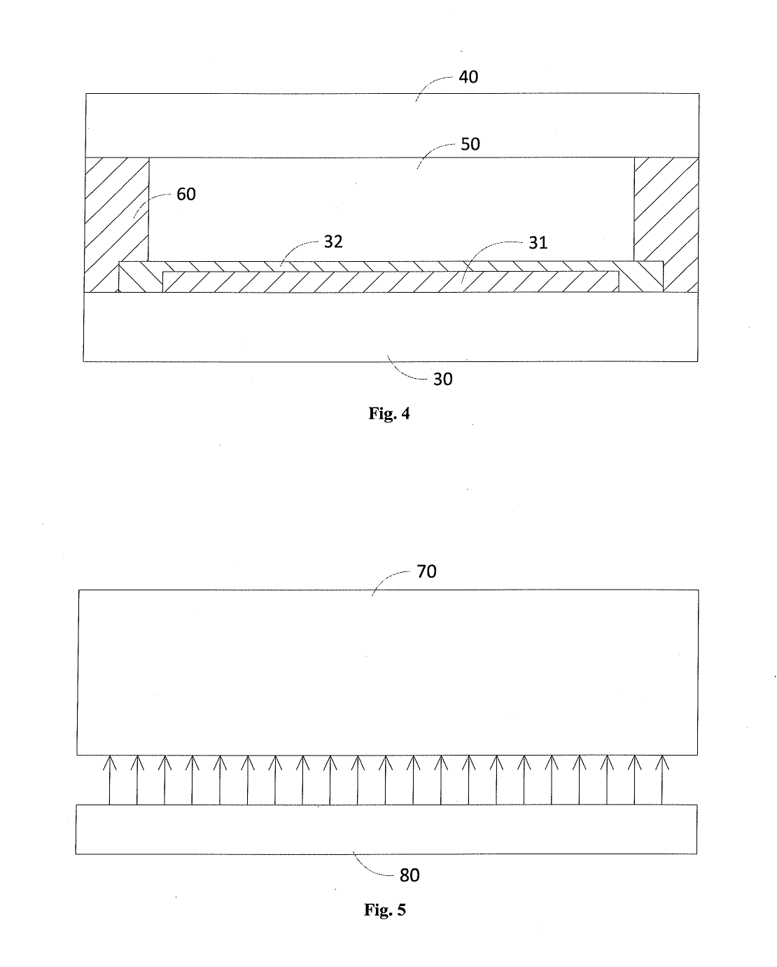

Referring to FIG. 4, FIG. 4 is a structural illustration of a liquid crystal display panel in accordance with an embodiment in the present disclosure.

The liquid crystal display panel may comprise an array substrate 30, a color filter substrate 40, and a liquid crystal layer 50 between the array substrate 30 and the color filter substrate 40.

A display region on the array substrate 30 may comprise a thin film transistor array and a pixel electrode. The display region on the color filter substrate 40 may comprise a filter layer and a common electrode. In addition, in a color filter on array (COA) type array substrate, a filter layer may be arranged on the array substrate 30, a common electrode layer may be arranged on the color filter substrate 40 opposite to the filter layer, and the filter layer may not be arranged on the color filter substrate 40.

The array substrate 30 and the color filter substrate 40 may be connected by a sealant area 60. An alignment film 32 may be arranged on at least one of the array substrate 30 and the color filter substrate 40, and the at least one of the array substrate 30 and the color filter substrate 40 comprises an active display area 31 and the sealant area 60. An edge of the alignment film 32 may be located between the sealant area 60 and an edge of an active display area 31.

Specifically, the alignment film 32 may be arranged on the substrate 30. The alignment film 32 may cover at least a part of the active display area 31. If the alignment film 32 covers the sealant area 60 area, the alignment film 32 may be etched, so that the edge of the alignment film 32 may be located between the edge of the active display area 31 and the sealant area 60. In addition, there may be a predetermined distance between the sealant area 60 and the active display area 31.

The alignment film 32 may be arranged on the array substrate 30 as shown in FIG. 4, and structures of the alignment film 32 arranged on the color filter substrate 40 may be similar to which, therefore no additional description is given herebelow.

The alignment film 32 may be manufactured by any one of the alignment film manufacturing methods of FIG. 1 and FIG. 3.

Referring to FIG. 5, FIG. 5 is a structural illustration of a liquid crystal display in accordance with an embodiment in the present disclosure.

The liquid crystal display may comprise a liquid crystal display panel 70 and a backlight 80. The liquid crystal display panel may be the liquid crystal display panel described in FIG. 4, therefore no additional description is given herebelow.

The present disclosure provides an alignment film manufacturing method, a liquid crystal display panel, and a liquid crystal display. The alignment film manufacturing method comprises: providing a substrate; defining an active display area and a sealant area on the substrate, wherein the sealant area is a strip area arranged around the active display area, and there is a predetermined distance between the sealant area and the active display area; arranging an alignment film on the substrate, wherein the alignment film covers at least a part of the active display area; and etching the alignment film, so that an edge of the alignment film is located between an edge of the active display area and the sealant area. By the above-mentioned one or more implementations, the present disclosure may improve an adhesion force between the sealant area and the substrate by a small portion which the sealant coated on the substrate. As compared with an entire alignment film which the sealant coated and having a same adhesion force, a size of a portion which the sealant coated may reduce in the present disclosure, and may meet requirements of a sealant coating for a narrow border substrate.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

What is claimed is:

1. An alignment film manufacturing method comprising:
providing a substrate;
defining an active display area and a sealant area on the substrate, wherein the sealant area is arranged along edges of the active display area, and there is a predetermined distance between adjacent portions of the sealant area and the active display area;
coating an alignment film solution on the substrate;
baking the substrate, to turn the alignment film solution into an alignment film;
enabling a liquid crystal molecule alignment ability of the alignment film by one of a rubbing alignment manner and a photo alignment manner, wherein the alignment film covers at least the whole active display area;
etching the alignment film by a gas lithography technology, so that edges of the alignment film are located between edges of the active display area and the sealant area.

2. The manufacturing method according to claim 1, wherein the etching of the alignment film comprises:
providing a gas lithography device;
predetermining a gas lithography boundary between edges of the active display area and the sealant area;
adjusting the gas lithography device to form a predetermined angle with the alignment film;
activating the gas lithography device, and moving the gas lithography device along the gas lithography boundary to remove part of the alignment film outside the gas lithography boundary.

3. The manufacturing method according to claim 2, further comprising:
detecting a gas pressure of the gas lithography device;
adjusting the gas pressure so that it is greater than an etching strength threshold of the alignment film.

4. The manufacturing method according to claim 2, wherein the gas lithography boundary is located between edges of the active display area and the sealant area, and adjacent to edges of the active display area.

5. The manufacturing method according to claim 1, wherein gas used in the gas lithography technology is selected from the group consisting of carbon dioxide, compressed air, and nitrogen.

6. An alignment film manufacturing method comprising:
providing a substrate;
defining an active display area and a sealant area on the substrate, wherein the sealant area is arranged along edges of the active display area, and there is a predetermined distance between adjacent portions of the sealant area and the active display area;
arranging an alignment film on the substrate, wherein the alignment film covers at least the whole active display area;
etching the alignment film, so that edges of the alignment film are located between edges of the active display area and the sealant area.

7. The manufacturing method according to claim 6, wherein the etching of the alignment film comprises:
etching the alignment film by a gas lithography technology, so that the edge of the alignment film is located between edges of the active display area and the sealant area.

8. The manufacturing method according to claim 7, the etching of the alignment film further comprises:
providing a gas lithography device;
predetermining a gas lithography boundary between edges of the active display area and the sealant area;
adjusting the gas lithography device to form a predetermined angle with the alignment film;
activating the gas lithography device, and moving the gas lithography device along the gas lithography boundary to remove part of the alignment film outside the gas lithography boundary.

9. The manufacturing method according to claim 8, further comprising:
detecting a gas pressure of the gas lithography device;
adjusting the gas pressure so that it is greater than an etching strength threshold of the alignment film.

10. The manufacturing method according to claim 8, wherein the gas lithography boundary is located between edges of the active display area and the sealant area, and adjacent to edges of the active display area.

11. The manufacturing method according to claim 7, wherein gas used in the gas lithography technology is selected from the group consisting of carbon dioxide, compressed air, and nitrogen.

12. The manufacturing method according to claim 6, wherein the arranging of the alignment film on the substrate comprises:
coating an alignment film solution on the substrate;
baking the substrate, to turn the alignment film solution into an alignment film;
enabling a liquid crystal molecule alignment ability of the alignment film by one of a rubbing alignment manner and a photo alignment manner.

13. A liquid crystal display comprising:
a backlight;
a liquid crystal display panel having, an array substrate, a color filter substrate, and a liquid crystal layer between the array substrate and the color filter substrate;
wherein the array substrate and the color filter substrate are connected by a sealant area; and
an alignment film arranged on at least one of the array substrate and the color filter substrate,
wherein at least one of the array substrate and the color filter substrate comprises an active display area and the sealant area and edges of the alignment film are located between the sealant area and edges of the active display area.

14. The liquid crystal display according to claim 13, wherein the alignment film is etched by a gas lithography technology, so that edges of the alignment film are located between edges of the active display area and the sealant area.

15. The liquid crystal display according to claim 14, wherein gas used in the gas lithography technology is selected from the group consisting of carbon dioxide, compressed air, and nitrogen.

16. The liquid crystal display according to claim 14, wherein a gas lithography boundary of the alignment film is located between edges of the active display area and the sealant area, and adjacent to edges of the active display area.

17. The liquid crystal display according to claim 13, wherein a predetermined distance is established between adjacent portions of the sealant area and the active display area.

18. The liquid crystal display according to claim 13, wherein at least a part of the sealant area is arranged on an area of one of the array substrate and the color filter substrate that is not covered by the alignment film.

19. The liquid crystal display according to claim 13, wherein the sealant area is arranged along edges of the active display area.
